(19) United States
(12) Patent Application Publication
(10) Pub. No.: US 2025/0306380 A1
(43) Pub. Date: Oct. 2, 2025

(54) IMAGE GENERATION DEVICE

(71) Applicant: Panasonic Intellectual Property Management Co., Ltd., Osaka (JP)

(72) Inventor: Shigetaka KASUGA, Osaka (JP)

(21) Appl. No.: 19/232,275

(22) Filed: Jun. 9, 2025

Related U.S. Application Data
(63) Continuation of application No. PCT/JP2023/043888, filed on Dec. 7, 2023.

(30) Foreign Application Priority Data
Dec. 22, 2022 (JP) 2022-205171

(51) Int. Cl. G02B 27/01; G02B 27/00

(52) U.S. Cl. CPC G02B 27/0172; G02B 27/0093; G02B 27/0176; G02B 2027/0138; G02B 2027/0154; G02B 2027/0178

(57) ABSTRACT

An image generation device includes: a light source; a scanner configured to perform scanning with light emitted from the light source; a controller configured to control the light source and the scanner, based on a video signal; a piezoelectric element placed in the scanner and configured to expand and contract in accordance with scanning with the light; and an edge detection circuit configured to detect an inflection point on a current waveform caused due to the piezoelectric element. The controller corrects a driving signal for switching a scanning speed of the light, based on a detection timing of the inflection point in the edge detection circuit.

### CROSS REFERENCE TO RELATED APPLICATION

This application is a continuation of International Application No. PCT/JP2023/043888 filed on Dec. 7, 2023, entitled “IMAGE GENERATION DEVICE”, which claims priority under 35 U.S.C. Section 119 of Japanese Patent Application No. 2022-205171 filed on Dec. 22, 2022, entitled “IMAGE GENERATION DEVICE”. The disclosures of the above applications are incorporated herein by reference.

### BACKGROUND OF THE INVENTION

### Field of the Invention

The present invention relates to an image generation device that generates an image by performing scanning with light.

### Description of Related Art

To date, as an image generation device that generates an image by performing scanning with light, a head-mounted display, such as goggles and glasses, that realizes AR (Augmented Reality) or VR (Virtual Reality) has been known, for example. In these devices, for example, light based on a video signal is applied toward a translucent display, and the reflected light is applied to the eyes of a user.

Alternatively, light based on the video signal is directly applied to the eyes of the user.

U.S. Pat. No. 9,986,215 describes a configuration that changes the linear density of an image by controlling the scanning speed of an MEMS mirror. In this configuration, the MEMS mirror is controlled such that the scanning speed in a region that does not correspond to the line of sight of the user becomes faster than a region that corresponds to the line of sight. Accordingly, the resolution of the image in the region not corresponding to the line of sight is reduced, whereby the eyes of the user are less likely to be tired.

When the control as above is performed, it is necessary to quickly change the high-resolution region and the low-resolution region in accordance with change in the line of sight. Therefore, it is necessary to quickly and accurately switch the scanning speed at the boundary between the high-resolution region and the low-resolution region.

### SUMMARY OF THE INVENTION

An image generation device according to a main aspect of the present invention includes: a light source; a scanner configured to perform scanning with light emitted from the light source; a controller configured to control the light source and the scanner, based on a video signal; a piezoelectric element placed in the scanner and configured to expand and contract in accordance with scanning with the light; and an edge detection circuit configured to detect an inflection point on a current waveform caused due to the piezoelectric element. The controller corrects a driving signal for switching a scanning speed of the light, based on a detection timing of the inflection point in the edge detection circuit.

In the image generation device according to the present aspect, based on the detection timing of the inflection point on the current waveform caused due to the piezoelectric element, the change point of the scanning speed of the light can be detected. Therefore, the actual change point of the scanning speed of the light can be detected in a period in one frame, and the driving signal to be applied to the next frame can be quickly and accurately corrected based on the detection timing of the inflection point. Therefore, the scanning speed of the light for image generation can be quickly and accurately switched.

The effects and the significance of the present

invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1 is a perspective view schematically showing a configuration of AR glasses according to an embodiment;

FIG. 2 schematically shows a configuration of a projection unit according to the embodiment;

FIG. 3 shows a configuration of a circuitry of an image generation device according to the embodiment;

FIG. 4 is a plan view showing a configuration of a second scanner according to the embodiment;

FIG. 5 schematically shows a generation method for a frame image according to the embodiment;

FIG. 6 is a block diagram showing a configuration of a mirror position detection circuit and a circuitry in the periphery thereof according to the embodiment;

FIG. 7 is a time chart schematically showing a driving signal for one frame for driving the second scanner, and a monitoring current, a monitoring voltage, and a pulse signal according to the embodiment;

FIG. 8 is a time chart schematically showing a correction method for the driving signal to be applied to the second scanner according to the embodiment;

FIG. 9A is a flowchart showing a correction process for the driving signal to be applied to the second scanner according to the embodiment;

FIG. 9B is a flowchart showing control of switching the light emission level of a light source according to the embodiment;

FIG. 10A to FIG. 10C each show a configuration of a level setting table according to the embodiment;

FIG. 11 is a block diagram showing a configuration of the mirror position detection circuit and a circuitry in the periphery thereof according to a modification; FIG. 12A shows a configuration of table information used in setting an initial driving signal according to the modification; and

FIG. 12B is a flowchart showing a process performed when an initial driving signal is set by using the table information according to the modification.

It is noted that the drawings are solely for description and do not limit the scope of the present invention in any way.

### DETAILED DESCRIPTION

Hereinafter, an embodiment of the present invention will be described with reference to the drawings. In the embodiment below, an example in which the present invention is applied to an image generation device for AR glasses is shown. However, the embodiment below is an example of embodiments of the present invention, and the present invention is not limited to the embodiment below in any way. For example, not limited to an image generation device for AR glasses, the present invention is also applicable to an image generation device for AR goggles, VR glasses, VR goggles, vehicle-mounted head-up displays, and the like.

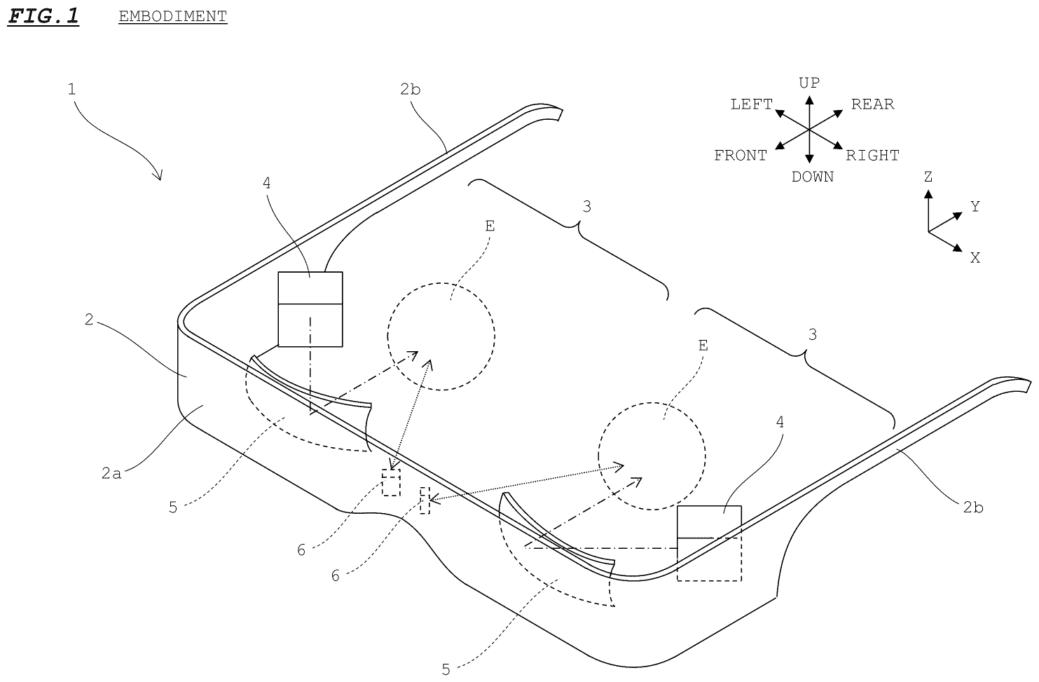

FIG. 1 is a perspective view schematically showing a configuration of AR glasses 1.

In FIG. 1, front, rear, left, right, up, and down directions of the AR glasses 1 and X, Y, and Z-axes orthogonal to each other are indicated. The X-axis positive direction, the Y-axis positive direction, and the Z-axis positive direction correspond to the right direction, the rear direction, and the up direction of the AR glasses 1, respectively.

The AR glasses 1 include a frame 2 and a pair of image generation devices 3. The pair of image generation devices 3 is in symmetry with each other with respect to a Y-Z plane passing through the center of the AR glasses 1. Each image generation device 3 includes a projection unit 4, a half mirror 5, and a detection unit 6. Similar to typical eyeglasses, the AR glasses 1 are worn on the head of a user.

The frame 2 is composed of a front face part 2a and a pair of support parts 2b. The pair of support parts 2b extend rearward from the right end and the left end of the front face part 2a. When the frame 2 is worn by the user, the front face part 2a is positioned in front of a pair of eyes E of the user. The front face part 2a is formed from a transparent material (e.g., resin, etc.).

The projection unit 4 is installed on the inner face of

each support part 2b. The projection unit 4 projects light modulated by a video signal, to a corresponding half mirror 5.

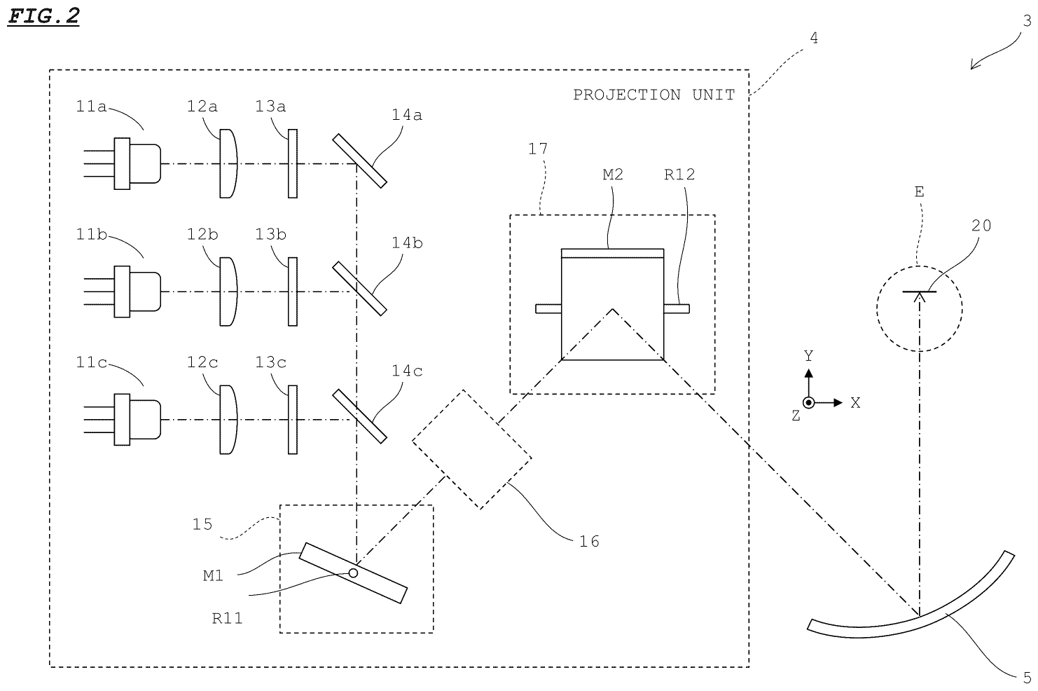

Each half mirror 5 is installed on the inner face of the front face part 2a. The half mirror 5 reflects the light projected from the corresponding projection unit 4 to the eye E of the user, and transmits therethrough light advancing in the front-rear direction. The light from the projection unit 4 reflected by the half mirror 5 is applied to the central fossa positioned at the center of the retina in the eye E. Accordingly, the user can visually grasp a frame image 20 (see FIG. 2) generated by the image generation device 3. Since the user can see the front of the AR glasses 1 through the half mirror 5, the user can visually grasp the state in front of the AR glasses 1 and the frame image 20 generated by the image generation device 3 superposed with each other.

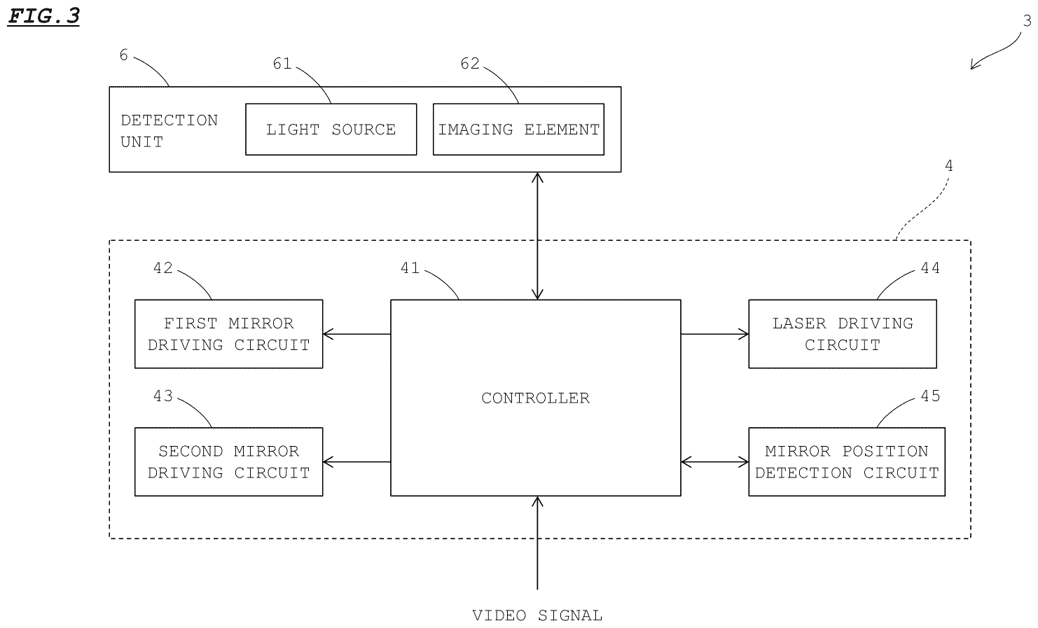

The pair of detection units 6 are installed on the inner face of the front face part 2a, and are positioned between the pair of half mirrors 5. The detection units 6 are used for detecting the line of sight of the user. Detection of the line of sight of the user will be described later with reference to FIG. 3.

FIG. 2 schematically shows a configuration of the projection unit 4.

The projection unit 4 includes light sources 11a, 11b, 11c, collimator lenses 12a, 12b, 12c, apertures 13a, 13b, 13c, a mirror 14a, dichroic mirrors 14b, 14c, a first scanner 15, a relay optical system 16, and a second scanner 17.

The light sources 11a, 11b, 11c are each a semiconductor laser light source, for example. The light source 11a emits laser light having a red wavelength included in a range of 635 nm or more and 645 nm or less, the light source 11b emits laser light having a green wavelength included in a range of 510 nm or more and 530 nm or less, and the light source 11c emits laser light having a blue wavelength included in a range of 440 nm or more and 460 nm or less.

In the present embodiment, a color image is generated as the frame image 20 described later, and thus, the projection unit 4 includes the light sources 11a, 11b, 11c that can emit red, green, and blue laser lights. When an image in a single color is displayed as the frame image 20, the projection unit 4 may include only one light source that corresponds to the color of the image. The projection unit 4 may be configured to include two light sources whose emission wavelengths are different from each other.

The lights emitted from the light sources 11a, 11b, 11c are converted into collimated lights by the collimator lenses 12a, 12b, 12c, respectively. The lights having passed through the collimator lenses 12a, 12b, 12c are shaped into approximately circular beams by the apertures 13a, 13b, 13c, respectively.

The mirror 14a substantially totally reflects the red light having passed through the aperture 13a. The dichroic mirror 14b reflects the green light having passed through the aperture 13b, and transmits therethrough the red light reflected by the mirror 14a. The dichroic mirror 14c reflects the blue light having passed through the aperture 13c, and transmits therethrough the red light and the green light having advanced via the dichroic mirror 14b. The mirror 14a and the two dichroic mirrors 14b, 14c are placed such that the optical axes of the lights in the respective colors emitted from the light sources 11a, 11b, 11c are caused to coincide with each other.

The first scanner 15 reflects the lights having advanced via the dichroic mirror 14c. The first scanner 15 is an MEMS (Micro Electro Mechanical System) mirror, for example.

The first scanner 15 is provided with a configuration that causes a first mirror M1 on which the lights having advanced via the dichroic mirror 14c are incident, to rotate about a rotation axis R11, which is parallel to the Z-axis direction, in accordance with a driving signal. Through rotation of the first mirror M1, the light reflection direction changes. Accordingly, the lights reflected by the first mirror M1 are scanned in the X-axis direction (horizontal direction) on the retina of the eye E.

The relay optical system 16 directs the lights reflected by the first scanner 15 toward the center of a second mirror M2 of the second scanner 17. That is, the lights incident on the first scanner 15 are deflected at a predetermined deflection angle by the first mirror M1. The relay optical system 16 directs each light at the deflection angle, toward the center of the second mirror M2. The relay optical system 16 has a plurality of mirrors, and causes the plurality of mirrors to reflect the lights reflected by the first scanner 15, toward the second scanner 17. Accordingly, a long optical path length can be realized inside the relay optical system 16, and the deflection angle of each light when viewed from the second mirror M2 can be suppressed.

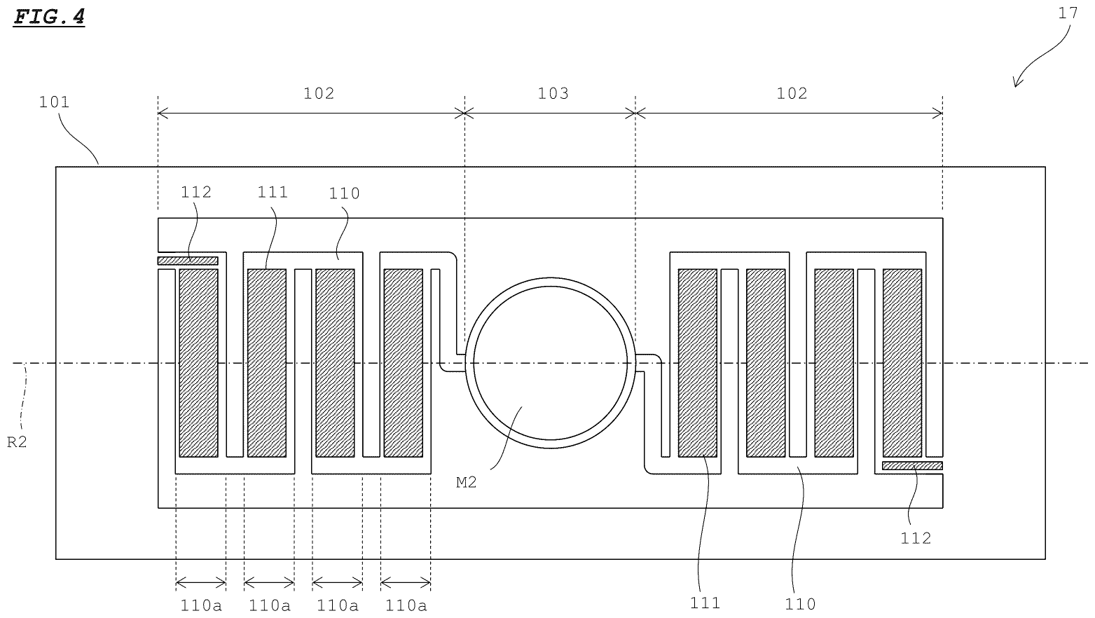

The second scanner 17 reflects the lights having advanced via the relay optical system 16. The second scanner 17 is an MEMS mirror. The second scanner 17 causes the second mirror M2 on which the lights having advanced via the relay optical system 16 are incident, to rotate about a rotation axis R12, which is parallel to an X-Y plane, in accordance with a driving signal. Through rotation of the second mirror M2, the light reflection direction changes. Accordingly, on the retina of the eye E, the lights scanned in the X-axis direction (horizontal direction) with the first scanner 15 are also scanned in the Z-axis direction (vertical direction). The configuration of the second scanner 17 will be described later with reference to FIG. 4.

The lights reflected by the second scanner 17, i.e.,

the lights emitted from the projection unit 4, are reflected by the half mirror 5 to form a frame image 20 on the retina of the eye E. That is, the light (the lights emitted from the light sources 11a to 11c) modulated by the video signal is scanned in the horizontal direction (the X-axis direction) and the vertical direction (the Z-axis direction) with the first scanner 15 and the second scanner 17, whereby the frame image 20 for one frame is formed on the retina of the eye E.

FIG. 3 shows a configuration of a circuitry of the image generation device 3.

The detection unit 6 includes a light source 61 and an imaging element 62, and is connected to a controller 41 of the projection unit 4. The light source 61 is an LED that emits light having an infrared wavelength, for example. The imaging element 62 is a CMOS image sensor or a CCD image sensor, for example. The light source 61 applies light to the eye E of the user in accordance with an instruction from the controller 41. The imaging element 62 captures an image of the eye E of the user in accordance with an instruction from the controller 41, and outputs the captured image to the controller 41.

The projection unit 4 includes the controller 41, a first mirror driving circuit 42, a second mirror driving circuit 43, a laser driving circuit 44, and a mirror position detection circuit 45.

The controller 41 includes an arithmetic processing unit such as a CPU and an FPGA, and a memory. The controller 41 processes a video signal from an external device to control each component of the projection unit 4. Based on the captured image from the detection unit 6, the controller 41 detects the line of sight of the user by the dark pupil method, the bright pupil method, the corneal reflex method, or the like, for example. Based on the detected line of sight of the user, the controller 41 acquires the viewpoint position in the frame image 20 formed on the retina of the user.

The first mirror driving circuit 42 drives the first mirror M1 of the first scanner 15 in accordance with a driving signal from the controller 41. The second mirror driving circuit 43 drives the second mirror M2 of the second scanner 17 in accordance with a driving signal from the controller 41.

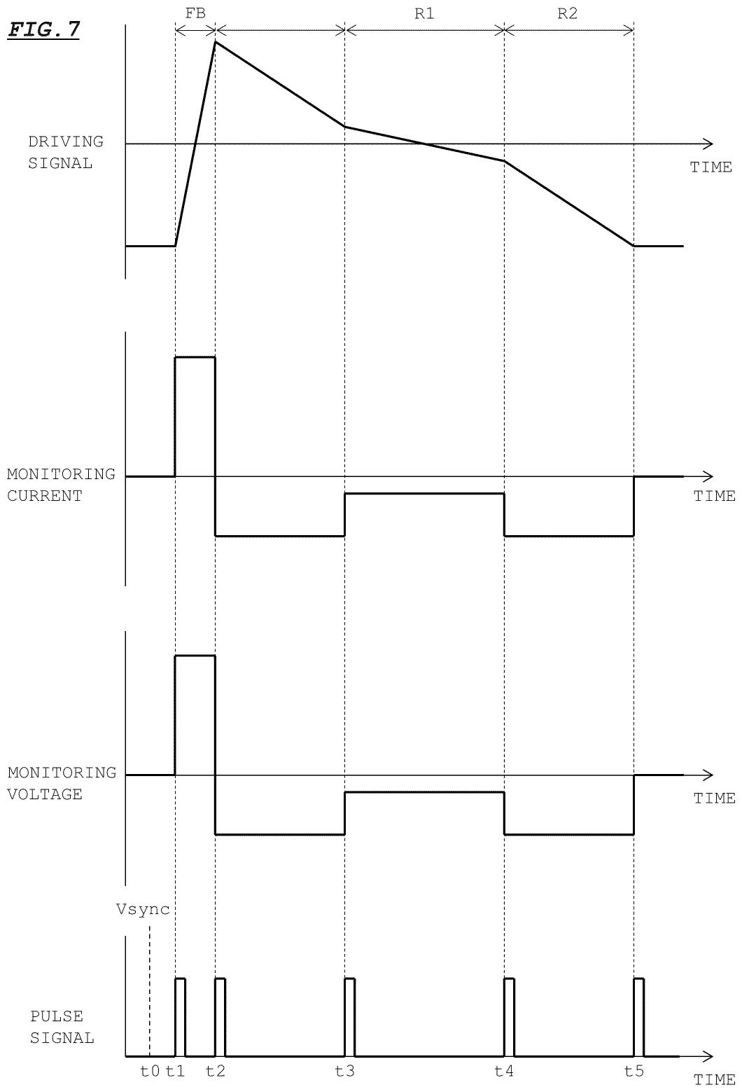

The mirror position detection circuit 45 outputs, to the controller 41, a detection signal according to the drive state of the second mirror M2 in the second scanner 17, i.e., the scanning position of light in the vertical direction (the Z-axis direction). The configuration of the mirror position detection circuit 45 will be described later with reference to FIG. 7.

Based on the detection signal from the mirror position detection circuit 45, the controller 41 outputs a driving signal to the second mirror driving circuit 43 such that the second mirror M2 rotates in the vertical direction (the Z-axis direction) in a desired drive waveform. In addition, based on the line of sight of the user detected by the detection unit 6, and the detection signal from the mirror position detection circuit 45, the controller 41 controls the second mirror driving circuit 43 such that the frame image 20 is depicted at the position of the line of sight.

The image generation device 3 may further include a detection circuit that detects the drive state of the first mirror M1 in the first scanner 15, i.e., the scanning position of light in the horizontal direction (the X-axis direction). In this case, based on a detection signal from this detection circuit, the controller 41 controls the first mirror driving circuit 42 such that the first mirror M1 rotates in the horizontal direction (the X-axis direction) in a desired drive waveform.

FIG. 4 is a plan view showing a configuration of the second scanner 17.

As shown in FIG. 4, in the present embodiment, the second scanner 17 is composed of a meander-type MEMS mirror (light deflector). However, the second scanner 17 is not limited to the meander-type MEMS mirror, and may be a light deflector having another configuration. The second scanner 17 includes a support part 101, a pair of drive parts 102, and a movable part 103. The support part 101 is a frame-shaped member having a predetermined thickness, and is composed of a silicon substrate, for example. In a plan view, the support part 101 has a rectangular contour.

Each drive part 102 includes a substrate 110 whose one end is connected to the support part 101 and whose other end is connected to the movable part 103, and four piezoelectric actuators 111 formed on the upper face of the substrate 110. The substrate 110 has a meander shape that meanders in a direction perpendicular to the rotation axis R12. The thickness of the substrate 110 is constant. The substrate 110 is formed integrally with the support part 101, from a material similar to that of the support part 101.

The four piezoelectric actuators 111 are respectively placed on the upper faces in four regions 110a, of the substrate 110, that extend in a direction perpendicular to the rotation axis R12. Each piezoelectric actuator 111 has a configuration in which a piezoelectric body having a constant thickness is sandwiched by an upper electrode and a lower electrode. The piezoelectric body is formed from PZT, for example. The upper electrode and the lower electrode are each formed from platinum, for example. Through application of a voltage (driving signal) between the upper electrode and the lower electrode, the piezoelectric actuator 111 (piezoelectric body) expands and contracts. Accordingly, the substrate 110 bends, whereby a driving force for driving the movable part 103 is generated.

The movable part 103 is supported by the pair of drive parts 102. The movable part 103 is formed integrally with the substrates 110 and the support part 101, from a material similar to that of the substrates 110 of the drive parts 102. In a plan view, the movable part 103 is circular. The shape of the movable part 103 may be another shape such as a square or the like. The thickness of the movable part 103 is a thickness similar to that of the substrates 110. On the back face of the movable part 103, a rib for suppressing warpage of the movable part 103 may be formed. On the upper face of the movable part 103, the second mirror M2 described above is formed. When the reflectance of the upper face of the movable part 103 is high, the upper face of the movable part 103 may serve as the second mirror M2.

When a driving voltage having the same phase has been applied to the odd-numbered piezoelectric actuators 111 counted from the movable part 103 side, the piezoelectric bodies of these piezoelectric actuators 111 are deformed and the odd-numbered substrates 110 (the regions 110a) vibrate in a bending manner. At this time, a driving voltage having a phase opposite to that of the driving voltage applied to the odd-numbered piezoelectric actuators 111 is applied to the even-numbered piezoelectric actuators 111 counted from the movable part 103 side. Accordingly, the piezoelectric bodies in the piezoelectric actuators 111 are deformed and the even-numbered substrates 110 (the regions 110a) are deformed in a bending manner. Thus, by the respective substrates 110 being deformed, the movable part 103 rotates about the rotation axis R12.

Further, in the substrate 110 of each drive part 102, a piezoelectric element 112 is placed on the upper face of a portion connected to the support part 101. Similar to the piezoelectric actuator 111, the piezoelectric element 112 has a configuration in which a piezoelectric body is sandwiched by an upper electrode and a lower electrode.

The mirror position detection circuit 45 shown in FIG. 3 outputs detection signals that are respectively based on deformations of these two piezoelectric elements 112. Here, when the movable part 103 and the second mirror M2 have rotated due to driving of the piezoelectric actuators 111, and in association with this, each piezoelectric element 112 has been deformed, a current according to the deformation flows in the piezoelectric element 112 due to the piezoelectric effect. In general, it is known that the magnitude of the current that flows in the piezoelectric element 112 is proportional to the speed at which the piezoelectric element 112 expands and contracts. That is, the conduction current of the piezoelectric element 112 corresponds to the derivative of the expansion and contraction state of the piezoelectric element 112. Therefore, this conduction current corresponds to the rotational position of the second mirror M2, i.e., the scanning position of light in the vertical direction.

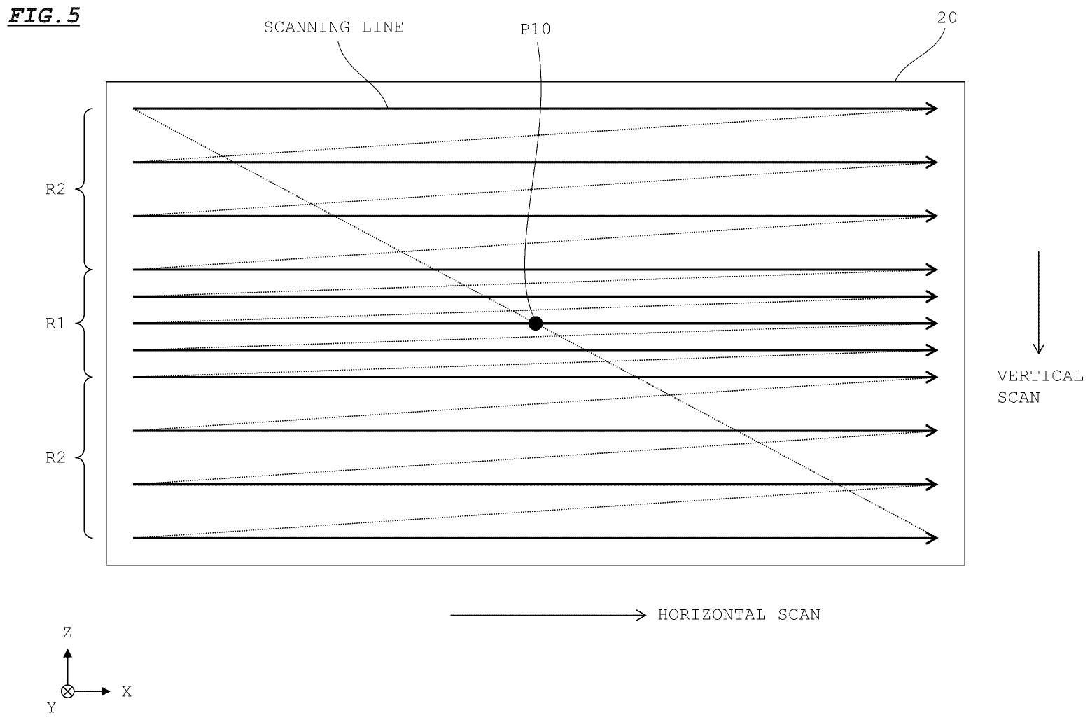

FIG. 5 schematically shows a generation method for the frame image 20 according to the embodiment.

In FIG. 5, for convenience, about five scanning lines are shown in a first image region R1, and about eight scanning lines in total are shown in a second image region R2. However, the actual number of scanning lines is much larger than this.

The controller 41 detects the line of sight of the user, based on a captured image acquired by the detection unit 6, and acquires a viewpoint position P10 on the frame image 20, based on the detected line of sight. In the first image region R1 having a predetermined number of scanning lines including the viewpoint position P10 on the frame image 20, the controller 41 causes the second scanner 17 to perform scanning with light at a first scanning speed. In the second image region R2 other than the first image region R1 of the frame image 20, the controller 41 causes the second scanner 17 to perform scanning with light at a second scanning speed faster than the first scanning speed. Scanning with light in the horizontal direction by the first scanner 15 is performed at a constant speed, irrespective of the first image region R1 or the second image region R2.

As for the first image region R1, the controller 41 controls the light sources 11a to 11c, the first scanner 15, and the second scanner 17 such that an inputted high-resolution video signal is applied to generate an image. As for the second image region R2, the controller 41 controls the light sources 11a to 11c, the first scanner 15, and the second scanner 17 such that a low-resolution video signal obtained by thinning-out scanning lines from an inputted high-resolution video signal is applied to generate an image. In a case where a low-resolution video signal is inputted to the controller 41, a high-resolution video signal can be generated by adding scanning lines obtained through interpolation between scanning lines.

The number of scanning lines included in the first image region R1 may be changed as appropriate. In FIG. 5, the first image region R1 has ranges corresponding to the same number of scanning lines above and below with respect to the viewpoint position P10. However, the number of scanning lines corresponding to the upper-side range and the number of scanning lines corresponding to the lower-side range may be different from each other. The numbers of scanning lines respectively included in the second image regions R2 on the upper side and lower side may be different from each other.

Meanwhile, when the scanning speed in the vertical direction is switched in accordance with the line of sight of the user as in FIG. 5, it is necessary to quickly change the arrangement and the range of the first image region R1 and the second image region R2 in accordance with change in the line of sight of the user. Therefore, at the boundary between the first image region R1 at a high resolution and the second image region R2 at a low resolution, the scanning speed in the vertical direction needs to be quickly and accurately switched.

Therefore, in the present embodiment, the mirror position detection circuit 45 is configured so as to be able to quickly and accurately switch the scanning speed in the vertical direction at the boundary between the first image region R1 and the second image region R2. By using the signal from the mirror position detection circuit 45, the controller 41 quickly and accurately sets the first image region R1 and the second image region R2 to positions and ranges according to change in the line of sight, and generates an image based on the high-resolution video signal and an image based on the low-resolution video signal in these respective first image region R1 and second image region R2. In the following, such configuration and control will be described.

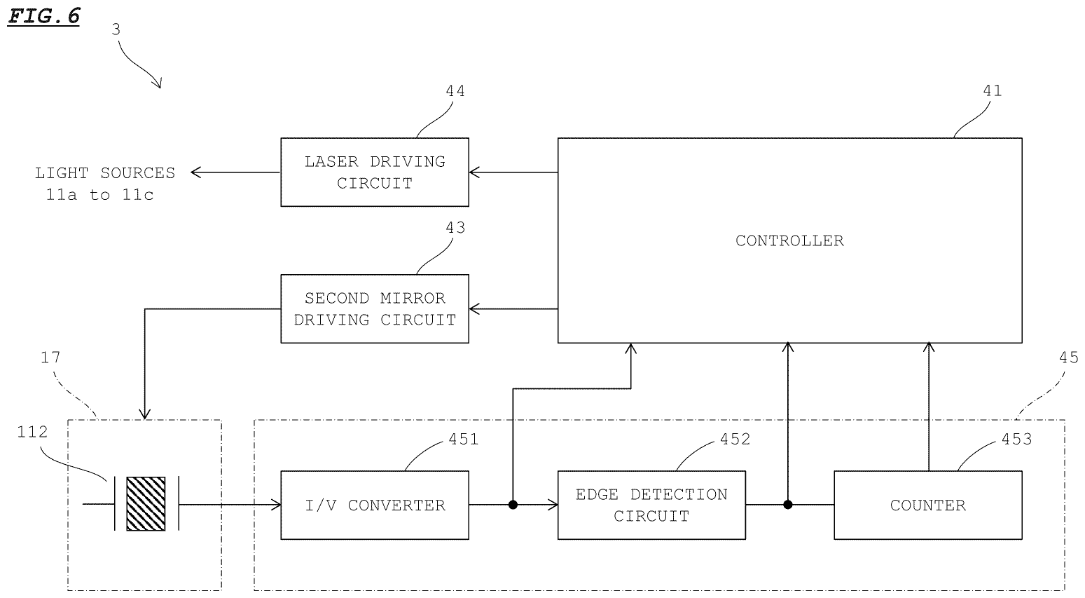

FIG. 6 is a block diagram showing a configuration of the mirror position detection circuit 45 and a circuitry in the periphery thereof according to the embodiment. In FIG. 6, the controller 41, the laser driving circuit 44, the second mirror driving circuit 43, and the second scanner 17 are also shown in addition to the mirror position detection circuit 45.

The mirror position detection circuit 45 includes an I/V converter 451, an edge detection circuit 452, and a counter 453.

The I/V converter 451 converts a current (hereinafter, referred to as “monitoring current”) having been generated in the piezoelectric element 112 of the second scanner 17, into a voltage (hereinafter, referred to as “monitoring voltage”). The I/V converter 451 outputs the monitoring voltage to each of the controller 41 and the edge detection circuit 452. The controller 41 converts the monitoring voltage into a digital signal using a built-in A/D converter, to perform processes described later.

The edge detection circuit 452 detects inflection points on the voltage waveform of the monitoring voltage having been inputted, and outputs a pulse signal in accordance with detection of each inflection point. Here, since the monitoring voltage has a waveform, similarly to the monitoring current, the edge detection circuit 452 detects the inflection point on the current waveform of the monitoring current through the monitoring voltage.

The counter 453 counts the reference clock from a frame start time point to each inflection point. Therefore, each count value of the counter 453 corresponds to the time from the frame start time point to each inflection point. Here, the frame start time point is defined by the vertical synchronizing signal (Vsync) of each frame, for example.

FIG. 7 is a time chart schematically showing a driving signal for one frame for driving the second scanner 17, and the monitoring current, the monitoring voltage, and the pulse signal.

In FIG. 7, periods corresponding to the first image region R1 and the second image region R2 in FIG. 5 are indicated as R1 and R2, and further, a flyback period, which is a period in which the scanning position is returned form the scan end position at the lower right to the scan start position at the upper left in the frame image 20 in FIG. 5, is indicated as FB. FIG. 7 shows a state where the first image region R1, the second image region R2, and the flyback period FB in the driving signal, and the first image region R1, the second image region R2, and the flyback period FB in the monitoring current and the monitoring voltage are aligned with each other on the time axis.

When the second scanner 17 is driven by the driving signal shown in FIG. 7, the piezoelectric element 112 placed in the second scanner 17 expands and contracts, and a monitoring current having a waveform according to this expansion and contraction speed is generated from the piezoelectric element 112. Therefore, the waveform of the monitoring current becomes a waveform approximately equivalent to the waveform obtained through differentiation of the driving signal. Since the monitoring voltage is obtained by converting the monitoring current into a voltage, the monitoring voltage has a waveform, similarly to the monitoring current.

The pulse signal is outputted at a timing according to each inflection point of the waveform of the monitoring voltage. Therefore, as shown in the lowermost part of FIG. 7, each pulse signal occurs at the change point of the scanning speed in the vertical direction, i.e., at the boundary between the flyback period FB and the period corresponding to the second image region R2, and at the boundary between the period corresponding to the first image region R1 and the period corresponding to the second image region R2.

With reference back to FIG. 6, the controller 41 corrects the driving signal to be applied to the second scanner 17, based on the pulse signal inputted from the edge detection circuit 452 and the counter value (elapsed time from the vertical synchronizing signal Vsync) inputted from the counter 453 at the time of input of the pulse signal.

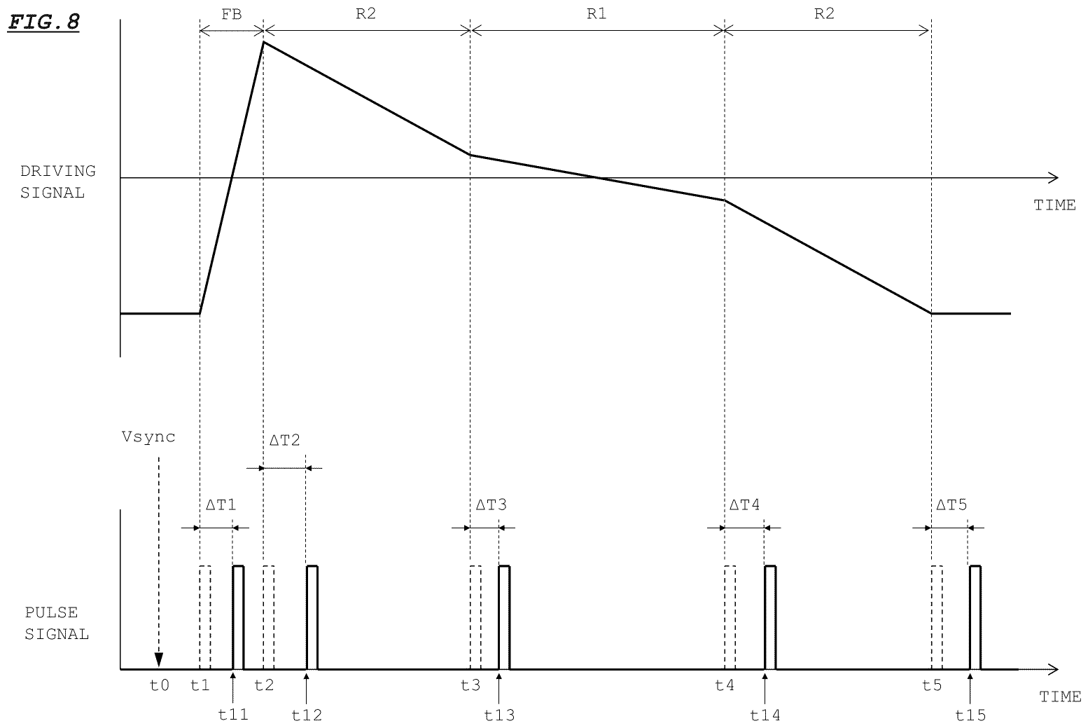

FIG. 8 is a time chart schematically showing a correction method for the driving signal to be applied to the second scanner 17.

In order to set the flyback period FB, the period corresponding to the first image region R1, and the periods corresponding to the two second image regions R2 according to the line of sight, to the driving signal, the controller 41 sets target timings t1 to t5 corresponding to the boundary between these periods, to the driving signal. Then, the driving signal based on these target timings t1 to t5 is generated and applied to the second scanner 17.

FIG. 8 shows the driving signal that is applied to one of the plurality of piezoelectric actuators 111 shown in FIG. 4. However, a similar driving signal is also applied to the other piezoelectric actuators 111. To a piezoelectric actuator 111 to which a driving voltage having an opposite phase is applied, a driving signal having a phase opposite to that of the driving signal in FIG. 8 is applied.

As a result of the driving signal being applied to the piezoelectric actuator 111, the monitoring current shown in FIG. 7 is generated from the piezoelectric element 112, and in accordance with this, the monitoring voltage and the pulse signal are respectively outputted from the I/V converter 451 and the edge detection circuit 452. At this time, due to a factor such as the environmental temperature of the image generation device 3, deviation of the actual drive of the second scanner 17 from the reference drive assumed according to the driving signal may occur.

In the lower part of FIG. 8, a pulse signal that is outputted when such a deviation has occurred is shown. The broken-line pulse signal is a pulse signal that is outputted when the second scanner 17 has performed reference drive. Here, the actual pulse signal is outputted at detection timings t11 to t15.

The controller 41 calculates respective difference values AT1 to AT5 between the target timings t1 to t5 and the detection timings t11 to t15. Then, the controller 41 sets correction values of the target timings t1 to t5 for suppressing these difference values AT1 to AT5, and controls the second mirror driving circuit 43 in FIG. 3 such that the driving signal having been corrected with the set correction values is applied to the second scanner 17 in the frame of the next time. Through this feedback control, the difference values AT1 to AT5 are quickly eliminated, and drive of the second scanner 17 is made appropriate.

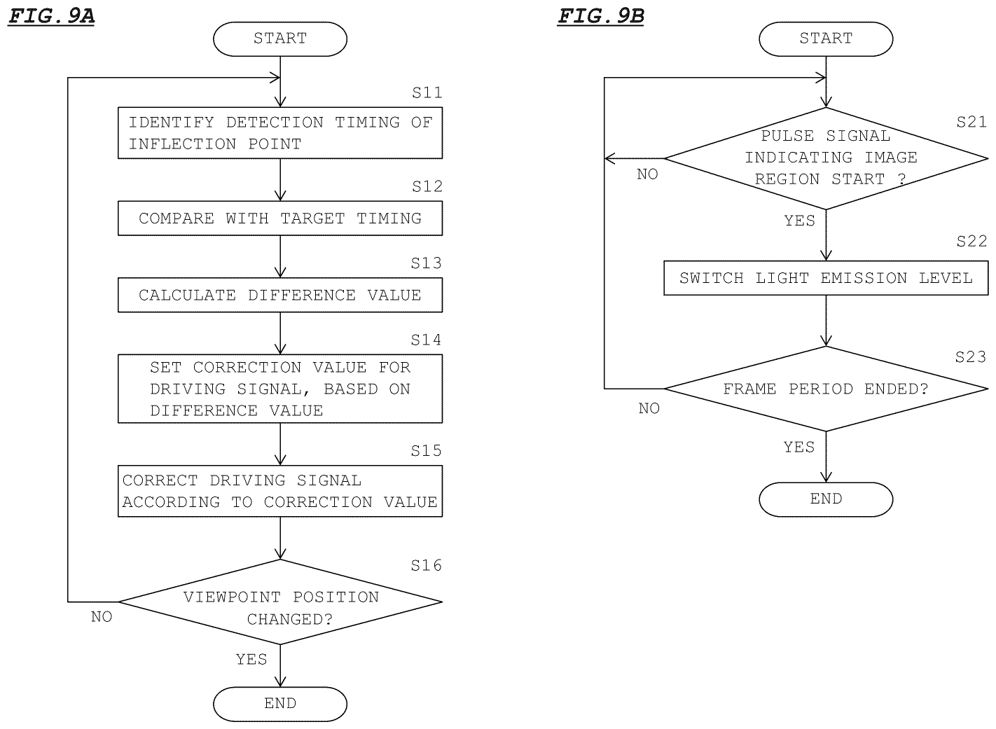

FIG. 9A shows a flowchart for executing the control in FIG. 8.

When the line of sight of the user has changed and the viewpoint position P10 has changed, the controller 41 sets the first image region R1 and the second image region R2, based on the changed viewpoint position P10, and, in accordance with this, sets the target timings t1 to t5. Then, based on the newly set target timings t1 to t5, the controller 41 sets an initial driving signal to be applied to the second scanner 17, and drives the second scanner 17 according to the set initial driving signal. In accordance with this, the controller 41 executes the feedback control in FIG. 9A, and corrects the driving signal for each frame.

From the pulse signal inputted from the edge detection circuit 452 at the time of frame scanning of this time, and the count value inputted from the counter 453 at that time, the controller 41 identifies the detection timings t11 to t15 of the respective inflection points (S11). Next, the controller 41 compares the identified respective detection timings t11 to t15 with the above-described target timings t1 to t5 (S12), and calculates the difference values AT1 to AT5 therebetween (S13). Then, the controller 41 sets correction values of the target timings t1 to t5 for suppressing the difference values AT1 to AT5 (S14), and causes the second mirror driving circuit 43 to output the driving signal corrected with the correction values, as the driving signal for the frame of the next time (S15).

Until the viewpoint position P10 changes (S16: NO), the controller 41 repeats the processes in steps S11 to S15 for each frame. Then, when the viewpoint position P10 has changed (S16: YES), the controller 41 ends the process in FIG. 9A. In accordance with this, the controller 41 sets an initial driving signal, based on the new viewpoint position P10 as described above, and drives the second scanner 17 according to the set initial driving signal, to execute the process in FIG. 9A again.

In the present embodiment, in addition to the control of correcting the driving signal in FIG. 9A, control of switching the light emission levels of the light sources 11a to 11c is performed based on the pulse signal outputted from the edge detection circuit 452.

FIG. 9B is a flowchart showing control of switching the light emission levels of the light sources 11a to 11c.

When a pulse signal has been inputted from the edge detection circuit 452, the controller 41 determines whether or not this pulse signal is a pulse signal indicating the start timing of a period corresponding to the first image region R1 or the second image region R2 (S21). For example, the controller 41 determines at what ordinal number from the vertical synchronizing signal Vsync the pulse signal has arrived.

As shown in FIG. 7, when the controller 41 has received the second pulse signal from the vertical synchronizing signal Vsync, the controller 41 determines that the start timing of the second image region R2 being the first one has arrived. Similarly, when the controller 41 has received the third and the fourth pulse signals from the vertical synchronizing signal Vsync, respectively, the controller 41 determines that the start timing of the first image region R1 and the start timing of the second image region R2 being the second one have arrived, respectively.

When having determined that the start timing of the first image region R1 or the second image region R2 has arrived (S21: YES), the controller 41 switches the light emission levels of the light sources 11a to 11c to light emission levels appropriate for the image region whose start timing has arrived (S22). That is, the first scanning speed in the vertical direction in the first image region R1 is slower than the second scanning speed in the vertical direction in the second image region R2. Therefore, when an image is to be displayed at the same brightness in the first image region R1 and the second image region R2, the controller 41 sets the light emission levels of the light sources 11a to 11c when the first image region R1 is scanned with light, to be lower than those when the second image region R2 is scanned with light.

Here, the controller 41 causes the light emission intensities (maximum light emission intensity) of the light sources 11a to 11c corresponding to the highest gradation of the video signal to be different for each image region, thereby setting the light emission level of each image region. That is, the maximum light emission intensities of the light sources 11a to 11c when the first image region R1 is scanned with light is set to be lower than the maximum light emission intensities of the light sources 11a to 11c when the second image region R2 is scanned with light, such that the brightness of the entirety of the frame image 20 becomes uniform. The maximum light emission intensity of each light source like this may be retained by the controller 41 in advance, in association with the first image region R1 and the second image region R2 (i.e., the scanning speed in the vertical direction).

When having switched the light emission levels in this manner, the controller 41 determines whether or not one frame period has ended (S23). Determination in step S23 is made based on whether or not the last pulse signal (the fifth pulse signal) among the five pulse signals shown in FIG. 7 has been received, for example. When the frame period has not ended (S23: NO), the controller 41 returns the process to step S21 and repeats the same process. Accordingly, every time the start timing of an image region (the first image region R1, the second image region R2) newly arrives, the light emission levels of the light sources 11a to 11c are switched.

Then, when one frame period has ended (S23: YES), the controller 41 ends the process in FIG. 9B. In accordance with this, the controller 41 executes the process in FIG. 9B again, to sequentially switch the light emission levels of the light sources 11a to 11c through the same process as the above.

The light emission levels in the scanning period of the first image region R1 and the second image region R2 may be set based on the voltage level (corresponding to the current level in each scanning period of the monitoring current generated from the piezoelectric element 112) of the monitoring voltage in the scanning period of the first image region R1 and the second image region R2.

That is, as shown in FIG. 7, the voltage level of the monitoring voltage in the scanning period of the first image region R1 and the second image region R2 corresponds to the scanning speed in the vertical direction in each scanning period. As described above, the light emission levels of the light sources 11a to 11c are switched in accordance with the difference in the scanning speed in the vertical direction. Therefore, it is also possible to switch the light emission levels of the light sources 11a to 11c in accordance with the voltage level of the monitoring voltage in the scanning period of the first image region R1 and the second image region R2.

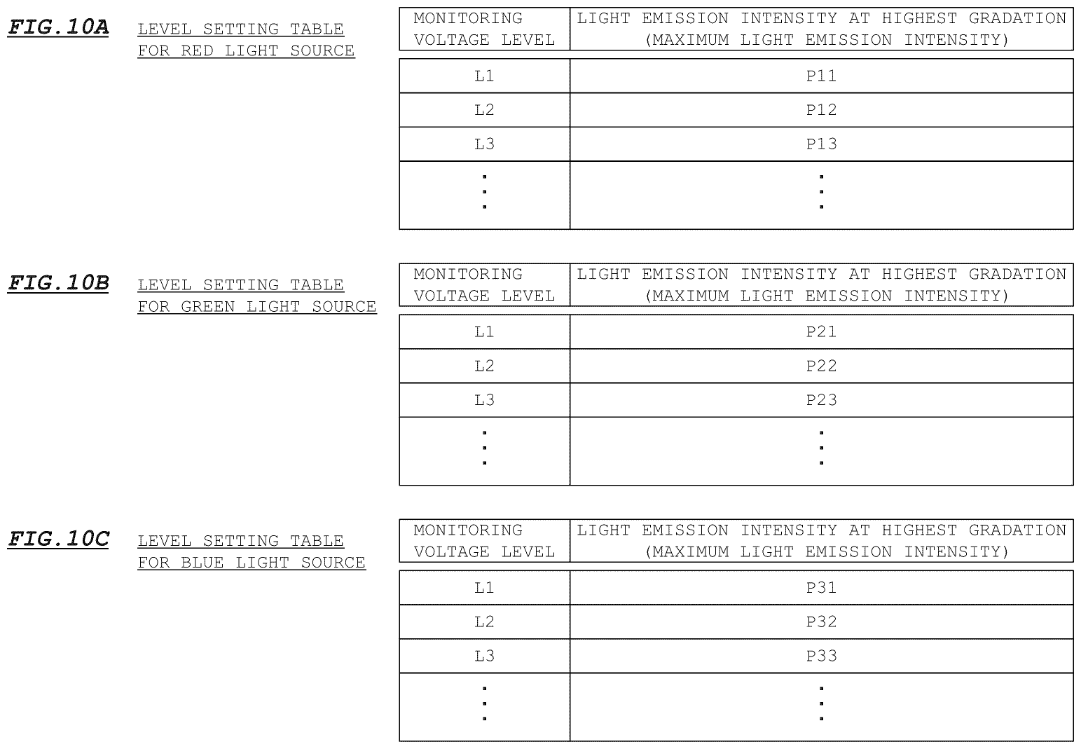

In this case, for example, level setting tables shown in FIGS. 10A to 10C are retained by the controller 41 for the respective light sources 11a, 11b, 11c (red light source, green light source, blue light source).

In each table, the voltage level of the monitoring voltage and the light emission intensity (maximum light emission intensity) of the light source 11a to 11c at the highest gradation of the video signal in the corresponding color are associated with each other. In one table, combinations of the monitoring voltage level and the maximum light emission intensity are set such that, when scanning with light is performed at a scanning speed in the vertical direction corresponding to each monitoring voltage level, if the light source emits light at the maximum light emission intensity associated with that monitoring voltage level, the same brightness (light amount per unit area) can be obtained.

Between the tables, the maximum light emission intensities are adjusted such that the light amount balance between colors is appropriate.

In the scanning in the vertical direction in the frame period of this time, the controller 41 detects the voltage level of the monitoring voltage in the scanning period of the first image region R1 and the second image region R2. Next, the controller 41 extracts the light emission intensity (maximum light emission intensity) at the highest gradation corresponding to the detected voltage level, from the level setting table for each light source (each color) shown in FIGS. 10A to 10C. For example, the controller 41 identifies a voltage level closest to the detected voltage level in each level setting table, and extracts the maximum light emission intensity associated with the identified voltage level, from the level setting table. Then, the controller 41 applies the extracted maximum light emission intensities to the light sources 11a to 11c respectively, and causes the laser driving circuit 44 to drive the light sources 11a to 11c.

In this control, unless scanning in the vertical direction in the first image region R1 and the second image region R2 starts, the voltage level of the monitoring voltage cannot be detected. Therefore, in the frame period of this time, it is difficult to perform, without delay, setting of the light emission levels of the light sources 11a to 11c based on the voltage level of the monitoring voltage. Therefore, in this control, it is preferable that: the voltage level of the monitoring voltage detected in the scanning period of each image region in the frame period of this time is used in the frame period of the next time; and, based on the level setting tables in FIGS. 10A to 10C, the maximum light emission intensities for the scanning period of the corresponding image region are applied to the light sources 11a to 11c.

According to this control, based on the voltage level having actually occurred in the monitoring voltage, i.e., the actual scanning speed in the vertical direction, the light emission levels of the light sources 11a to 11c are set. Therefore, light emission levels that are more appropriate for actual operation can be applied to the light sources 11a to 11c. Therefore, the brightness of the entirety of the frame image 20 can be more appropriately made uniform.

### <Effects of Embodiment>

According to the embodiment above, the following effects are exhibited.

As shown in FIG. 6, the image generation device 3 includes: the light sources 11a to 11c; the second scanner 17 that performs scanning with lights emitted from the light sources 11a to 11c; the controller 41 that controls the light sources 11a to 11c and the second scanner 17, based on a video signal; the piezoelectric element 112 that is placed in the second scanner 17 and that expands and contracts in accordance with scanning with the lights; and the edge detection circuit 452 that detects an inflection point on a current waveform (monitoring current) caused due to the piezoelectric element 112. The controller 41 corrects the driving signal for switching the scanning speed of the lights, based on the detection timing of the inflection point in the edge detection circuit 452.

According to this configuration, as shown in FIG. 8, based on the detection timings t11 to t15 of the inflection points (pulse signal) on the current waveform (monitoring current) caused due to the piezoelectric element 112, the change point in the scanning speed of the lights can be detected. Therefore, the actual change point (the detection timings t11 to t15) of the scanning speed of the lights can be detected in a period in one frame, and the driving signal to be applied to the next frame can be quickly and accurately corrected based on the detection timings t11 to t15 of the inflection points (pulse signal). Therefore, the scanning speed of the lights for image generation can be quickly and accurately switched at the target timings t1 to t5.

As described with reference to FIG. 8 and FIG. 9A, the controller 41 sets (step S15 in FIG. 9A) correction values for the driving signal for the next frame, based on the difference values AT1 to AT5 between the detection timings t11 to t15 of the inflection points (pulse signal) and the target timings t1 to t5 for switching the scanning speed. Therefore, the driving signal can be quickly and accurately corrected so as to eliminate the difference values AT1 to AT5.

As shown in FIG. 9B, based on the detection timings t12 to t14 of the inflection points (pulse signal) (S21: YES), the controller 41 switches the light emission levels of the light sources 11a to 11c (S22). Accordingly, the light emission levels of the light sources 11a to 11c can be smoothly switched to the light emission levels appropriate for the scanning speed in the vertical direction in the first image region R1 and the second image region R2.

As described with reference to FIGS. 10A to 10C, based on the current level (corresponding to the voltage level of the monitoring voltage), in each scanning period corresponding to the first image region R1 and the second image region R2, of the current waveform (corresponding to the voltage waveform of the monitoring voltage) caused due to the piezoelectric element 112, the controller 41 sets light emission levels of the light sources 11a to 11c in each scanning period. According to this control, as described above, based on the current level (corresponding to the voltage level of the monitoring voltage) actually caused in the monitoring current (corresponding to the monitoring voltage), i.e., the actual scanning speed in the vertical direction, the light emission levels of the light sources 11a to 11c are set. Therefore, light emission levels more appropriate for actual operation can be applied to the light sources 11a to 11c. Therefore, the brightness of the entirety of the frame image 20 can be more appropriately made uniform.

As shown in FIG. 4, the piezoelectric element 112 is placed in the second scanner 17 so as to detect the scanning position of lights in the vertical direction, and as described with reference to FIG. 6 to FIG. 8, the controller 41 corrects the driving signal for switching the scanning speed of the lights in the vertical direction, based on the detection timings t11 to t15 of the inflection points (pulse signal) in the edge detection circuit 452, and applies the corrected driving signal to the scanning in the frame of the next time. Accordingly, in the frame of the next time, scanning with respect to the flyback period FB, the first image region R1, and the two second image regions R2 can be appropriately performed, and the scanning speed of the lights for image generation can be quickly and accurately switched at the target timings t1 to t5.

### <Modification>

In the embodiment above, when the line of sight of the user has changed, the first image region R1 and the second image region R2 are set based on the changed viewpoint position P10, and in accordance with this, the target timings t1 to t5 are set. Then, the initial driving signal after the line of sight has changed is set based on the newly set target timings t1 to t5, and then, through the feedback control shown in FIG. 8 and FIG. 9A, the driving signal is corrected for each frame.

In contrast, in the present modification, a temperature sensor that detects the environmental temperature of the image generation device 3 is further placed. The controller 41: retains table information in which a representative value of the difference values AT1 to AT5 for each temperature is associated with the corresponding temperature; after the line of sight has changed, extracts, from the table information, a representative value associated with the temperature detected by the temperature sensor; and sets an initial driving signal, based on the extracted representative value and the target timings.

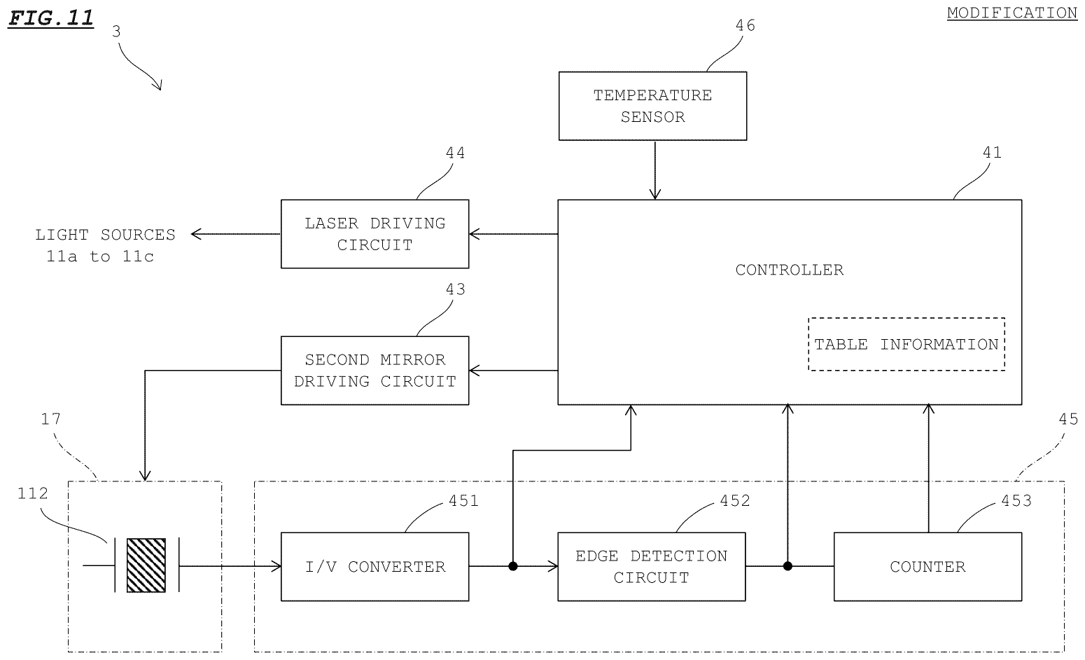

FIG. 11 is a block diagram showing a configuration of the mirror position detection circuit 45 and a circuitry in the periphery thereof according to the modification.

As shown in FIG. 11, the image generation device 3 further includes a temperature sensor 46. The temperature sensor 46 detects the environmental temperature of the image generation device 3 and outputs the environmental temperature to the controller 41. The controller 41 retains table information in which a temperature and a representative value of the difference values are associated with each other. After the line of sight has changed, the controller 41 sets an initial driving signal to be used in the feedback control, based on the table information and the temperature detected by the temperature sensor 46.

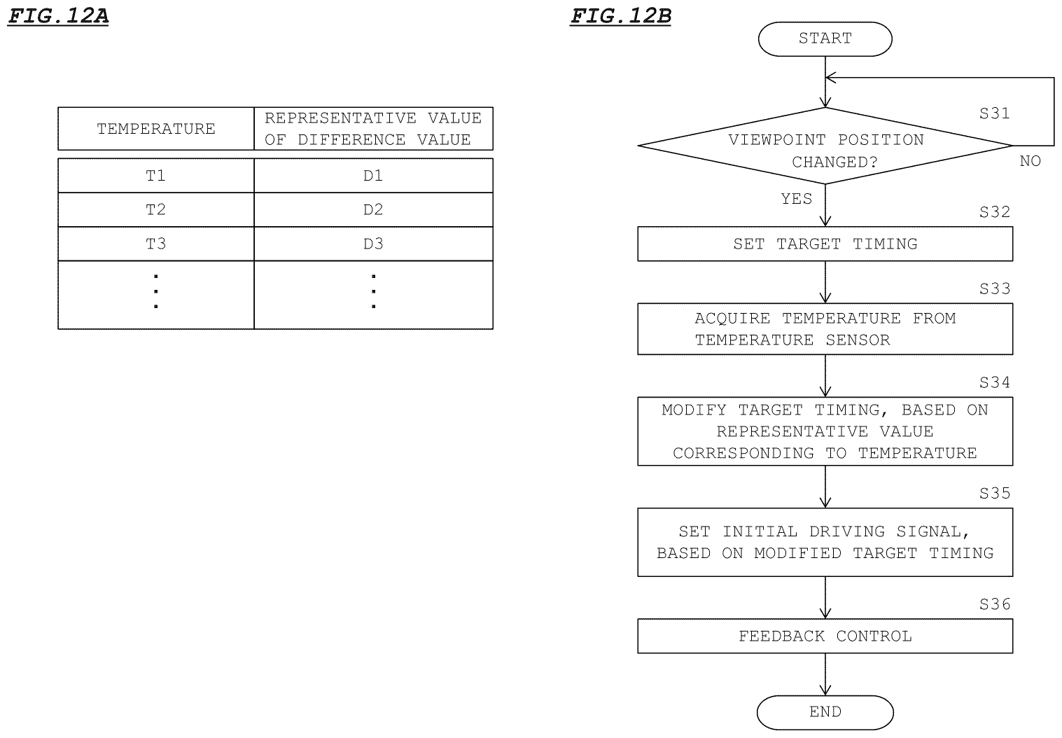

FIG. 12A shows a configuration of the table information used in setting of the initial driving signal according to the modification.

The table information is configured such that a representative value of the difference values is associated with each temperature. The representative value of the difference values is a representative value of the difference values firstly caused when the feedback control in FIG. 9A has been performed under a corresponding temperature condition from the initial driving signal set based on the above-described target timings. This representative value can be acquired by, for example, while various target timings are set under a corresponding environmental temperature, executing the above-described feedback control and subjecting the first difference values caused at that time to statistical processing or learning processing. In the case of statistical processing, the representative value is acquired as the average value, the median, the mode, or the like of these difference values. When the representative value is positive, the difference has occurred in the forward direction of time. When the representative value is negative, the difference has occurred in the backward direction of time.

The representative value of the difference values may be uniformly set for all the target timings. In this case, the first difference values acquired with respect to all the target timings under the corresponding environmental temperature are subjected to statistical processing or learning processing, and a uniform representative value is set for all the target timings.

Alternatively, the representative value of the difference values may be set for each sequential order of the target timings. For example, when five target timings are set to the driving signal as in FIG. 8, a representative value of the difference values is set for each sequential order from the first to the fifth. In this case, the above-described statistical processing or learning processing is executed for each sequential order, and a representative value is set for each sequential order. Therefore, the table information in FIG. 12A is retained by the controller 41 for each sequential order.

FIG. 12B is a flowchart showing a process performed when the initial driving signal is set by using the table information.

When the viewpoint position P10 of the user has changed (S31: YES), the controller 41 sets the first image region R1 and the second image region R2, based on the changed viewpoint position P10, and in accordance with this, sets the target timings t1 to t5 (S32). Next, the controller 41 acquires the environmental temperature from the temperature sensor 46 (S33), and acquires, from the table information, a representative value (a representative value associated with the temperature closest to the acquired temperature) corresponding to the acquired temperature. Then, the controller 41 modifies the target timings t1 to t5, based on the acquired representative value (S34).

In step S34, the controller 41 subtracts the representative value from the target timings t1 to t5, to acquire modified target timings t1′ to t5′. Therefore, when the representative value is negative, the absolute value of the representative value is added to the target timings t1 to t5, whereby the modified target timings t1′ to t5′ are calculated.

As described above, when a representative value ATtv is uniformly set to all the target timings t1 to t5, the representative value Ttv is subtracted from each target timing t1 to t5, whereby the modified target timing t1′ to t5′ is calculated. When representative values ATtv1 to ATtv5 are set for the respective target timings t1 to t5, the representative values ATtv1 to ATtv5 are respectively subtracted from the target timings t1 to t5, whereby the modified target timing t1′ to t5′ are calculated.

The controller 41 sets an initial driving signal, based on the modified target timings t1′ to t5′, and causes the second scanner 17 to perform scanning according to the set initial driving signal (S35). Then, after having caused the second scanner 17 to start scanning, the controller 41 executes the feedback control in FIG. 9A (S36).

According to the control in the modification, since the feedback control is performed based on the initial driving signal appropriate for the environmental temperature at that time, the first difference values AT1 to AT5 shown in FIG. 8 can be suppressed. That is, the drive characteristics of the second scanner 17 can change in accordance with change in the environmental temperature. Therefore, if the initial driving signal is set based on the target timings t1 to t5 that are fixed, time deviation from the ideal waveform according to change in the environmental temperature may be caused in the monitoring current and the monitoring voltage that are obtained during the drive using this driving signal. Thus, the difference values AT1 to AT5 between the target timings t1 to t5 and the detection timings t11 to t15 of the pulse signal in FIG. 8 can change in accordance with the environmental temperature.

In contrast, according to the control in the present modification, the target timings t1 to t5 are modified based on the above-described representative value associated with the environmental temperature at each time. That is, the difference value (representative value) that can occur at the environmental temperature is subtracted from the target timings t1 to t5, whereby the modified target timings t1′ to t5′ are calculated. Therefore, the initial driving signal set based on the modified target timings t1′ to t5′ is more likely to be adapted to the drive characteristics of the second scanner 17 at the environmental temperature at that time. Therefore, the difference values AT1 to AT5 firstly caused in the feedback control are much more suppressed as compared with the case when the initial driving signal is set based on the target timings t1 to t5 as in the embodiment above. Accordingly, in the feedback control thereafter, the difference values AT1 to AT5 can be more quickly eliminated. Therefore, the image can be more stably and quickly displayed in the first image region R1 and the second image region R2.

The table information in FIG. 12A may be further updated using the difference values AT1 to AT5 firstly caused in the feedback control. That is, in table information, the representative value associated with the environmental temperature used at the time of the feedback control may be further updated through a process using the difference values AT1 to AT5 firstly caused in the feedback control.

For example, when the representative values ATtv1 to ATtv5 have been set in the sequential order of the target timings t1 to t5, a value obtained by multiplying the firstly caused difference value AT1 to AT5 by a coefficient less than 1 is subtracted from the representative value ATtv1 to ATtv5, whereby new representative values ATtv1 to ATtv5 may be set. When the representative value Ttv is uniformly set to the target timings t1 to t5, a value obtained by multiplying the average value of the firstly caused difference values AT1 to AT5 by a coefficient less than 1 is subtracted from the representative value ATtv, whereby a new representative value ATtv may be set.

Accordingly, even when the temperature characteristics of the second scanner 17 have changed over time, the representative value can be set to a value according to the temperature characteristics at that time.

### <Other Modifications>

In the embodiment above, as shown in FIG. 4, the piezoelectric element 112 is placed at the connection part of the drive part 102 connected to the support part 101. However, the position where the piezoelectric element 112 is placed is not limited thereto. The piezoelectric element 112 may be placed at a position where the rotational position (the scanning position of light) of the second mirror M2 can be appropriately detected.

In the embodiment above, with respect to one driving signal out of the two driving signals having opposite phases to each other, the feedback control using the pulse signal has been shown. However, with respect to the other driving signal as well, similar control may be executed. In this case, one piezoelectric element 112 is placed at a position where the monitoring current according to one driving signal occurs, and the other piezoelectric element 112 is placed at a position where the monitoring current according to the other driving signal occurs. Alternatively, based on the monitoring current according to one driving signal, this driving signal may be corrected through feedback control, and the corrected driving signal may be converted so as to have the opposite phase, whereby the other driving signal may be generated.

In the embodiment above, the first mirror M1 and the second mirror M2 are separately provided. However, instead of the first mirror M1 and the second mirror M2, one mirror that rotates about two axes may be provided. In this case, at a drive part that causes this mirror to rotate in the vertical direction, a piezoelectric element 112 for mirror position detection may be placed.

In the embodiment above, control according to the present invention is applied to scanning with light in the vertical direction. However, when the scanning speed of the light is switched in the horizontal direction, control according to the present invention may be applied to scanning with light in the horizontal direction. In this case, the piezoelectric element 112 is placed in the first scanner 15, and the conduction current outputted from piezoelectric element 112 during driving of the first scanner 15 is inputted to the I/V converter 451 in FIG. 6.

In the embodiment above, an example in which the present invention is applied to the image generation device 3 mounted to the AR glasses 1 has been shown. However, the image generation device to which the present invention is applied is not limited thereto. The feedback control according to the present invention can also be used in various devices as long as the current outputted due to the piezoelectric effect from the piezoelectric element is used.

Various modifications can be made as appropriate to the embodiment of the present invention, without departing from the scope of the technological idea defined by the claims.

### (Additional Notes)

The following technologies are disclosed by the description of the embodiment above.

### (Technology 1)

An image generation device comprising:
a light source;
a scanner configured to perform scanning with light emitted from the light source;
a controller configured to control the light source and the scanner, based on a video signal;
a piezoelectric element placed in the scanner and configured to expand and contract in accordance with scanning with the light; and
an edge detection circuit configured to detect an inflection point on a current waveform caused due to the piezoelectric element, wherein
the controller corrects a driving signal for switching a scanning speed of the light, based on a detection timing of the inflection point in the edge detection circuit.

According to this technology, based on the detection timing of the inflection point on the current waveform caused due to the piezoelectric element, the change point of the scanning speed of the light can be detected. Therefore, the actual change point of the scanning speed of the light can be detected in a period in one frame, and the driving signal to be applied to the next frame can be quickly and accurately corrected based on the detection timing of the inflection point. Therefore, the scanning speed of the light for image generation can be quickly and accurately switched.

### (Technology 2)

The image generation device according to technology 1, wherein
based on a difference value between the detection timing of the inflection point and a target timing for switching the scanning speed, the controller sets a correction value for the driving signal for a next frame.

According to this technology, the driving signal can be quickly and accurately corrected so as to eliminate the difference value.

### (Technology 3)

The image generation device according to technology 2, comprising
a temperature sensor configured to detect an environmental temperature of the image generation device, wherein
the controller
   retains table information in which a representative value of the difference value for each temperature is associated with a corresponding temperature,
   extracts, from the table information, the representative value associated with a temperature detected by the temperature sensor, and
   sets the driving signal to serve as an initial driving signal, based on the extracted representative value and the target timing.

According to this technology, since the initial driving signal appropriate for the environmental temperature at that time is set, the driving signal to be applied to the next frame can be more quickly corrected based on the detection timing of the inflection point.

### (Technology 4)

The image generation device according to any one of technologies 1 to 3, wherein
based on the detection timing of the inflection point, the controller switches a light emission level of the light source.

According to this technology, the light emission level of the light source can be smoothly switched to the light emission level appropriate for the scanning speed.

### (Technology 5)

The image generation device according to any one of technologies 1 to 4, wherein
based on a current level, in each scanning period, of a current waveform caused due to the piezoelectric element, the controller sets a light emission level of the light source in the scanning period.

According to this technology, based on the current level actually caused in the monitoring current, i.e., the actual scanning speed, the light emission level of the light source is set. Therefore, a light emission level more appropriate for actual operation can be applied to the light source. Therefore, the brightness of the entirety of the image can be more appropriately made uniform.

### (Technology 6)

The image generation device according to any one of technologies 1 to 5, wherein
the piezoelectric element is placed so as to detect a scanning position of light in a vertical direction, and
the controller corrects a driving signal for switching a scanning speed of the light in the vertical direction, based on the detection timing of the inflection point in the edge detection circuit.

According to this technology, the scanning speed of the light in the vertical direction can be quickly and accurately switched.

What is claimed is:

1. An image generation device comprising:
a light source;
a scanner configured to perform scanning with light emitted from the light source;
a controller configured to control the light source and the scanner, based on a video signal;
a piezoelectric element placed in the scanner and configured to expand and contract in accordance with scanning with the light; and
an edge detection circuit configured to detect an inflection point on a current waveform caused due to the piezoelectric element, wherein
the controller corrects a driving signal for switching a scanning speed of the light, based on a detection timing of the inflection point in the edge detection circuit.

2. The image generation device according to claim 1, wherein
based on a difference value between the detection timing of the inflection point and a target timing for switching the scanning speed, the controller sets a correction value for the driving signal for a next frame.

3. The image generation device according to claim 2, comprising
a temperature sensor configured to detect an environmental temperature of the image generation device, wherein
the controller
retains table information in which a representative value of the difference value for each temperature is associated with a corresponding temperature,
extracts, from the table information, the representative value associated with a temperature detected by the temperature sensor, and
sets the driving signal to serve as an initial driving signal, based on the extracted representative value and the target timing.

4. The image generation device according to claim 1, wherein
based on the detection timing of the inflection point, the controller switches a light emission level of the light source.

5. The image generation device according to claim 1, wherein
based on a current level, in each scanning period, of a current waveform caused due to the piezoelectric element, the controller sets a light emission level of the light source in the scanning period.

6. The image generation device according to claim 1, wherein
the piezoelectric element is placed so as to detect a scanning position of light in a vertical direction, and
the controller corrects a driving signal for switching a scanning speed of the light in the vertical direction, based on the detection timing of the inflection point in the edge detection circuit.
